(19) United States
(12) Patent Application Publication
(10) Pub. No.: US 2016/0140428 A1
(43) Pub. Date: May 19, 2016

(54) ELECTRONIC DEVICE, METHOD OF DISPLAYING CODE, AND RECORDING MEDIUM

(71) Applicant: CASIO COMPUTER CO., LTD., Tokyo (JP)

(72) Inventors: Saburo KAMITANI, Tokyo (JP); Manato ONO, Wako-shi (JP)

(73) Assignee: CASIO COMPUTER CO., LTD., Tokyo (JP)

(21) Appl. No.: 14/854,887

(22) Filed: Sep. 15, 2015

(30) Foreign Application Priority Data
Nov. 13, 2014 (JP) 2014-230259

(51) Int. Cl. G06K 19/06; G06K 7/10

(52) U.S. Cl. CPC G06K 19/06037; G06K 7/1095

(57) ABSTRACT

An electronic device including: a display unit which displays a code generated based on tabular data; and a processor, wherein the processor performs: a compressing process of compressing numerical data having a plurality of digits and contained in the tabular data by reducing the number of digits of the numerical data; an encoding process of encoding the tabular data containing the numerical data compressed through the compressing process; and a code displaying process of displaying a code obtained by the encoding process on the display unit.

### CROSS-REFERENCE TO RELATED APPLICATIONS

This application is based upon and claims the benefit of priority from the prior Japanese Patent Application No. 2014-230259 filed on Nov. 13, 2014, the entire contents of which are incorporated herein by reference.

### BACKGROUND OF THE INVENTION

1. Field of the Invention

The present invention relates to electronic devices displaying two-dimensional codes, and methods of displaying codes.

2. Description of the Related Art

Various electronic devices have recently been developed that display two-dimensional codes, such as a QR code (registered trademark), on their displays.

For example, Patent Document 1 (Japanese Patent Application Laid-Open Publication No. 2011-76540) discloses a technique for readily transferring text data edited in a document editor to another electronic device by encoding the text data into a two-dimensional code, displaying the code, capturing the code into, for example, a cellular phone having an imaging function, and uploading the captured data to a predetermined website or transferring the captured data to a personal computer through Internet mail.

An electronic device, such as a scientific calculator, can perform various computations and process tabular data (also referred to as table data, etc.) used in statistical computations and table computations using spreadsheets.

Unfortunately, a large amount of tabular data encoded into, for example, a two-dimensional code may be displayed as a plurality of divided two-dimensional codes. Imaging those two-dimensional codes one by one with a smartphone with an imaging function is a considerable burden on a user.

The present invention is made in view of the above problems, and it is an object of the present invention to provide an electronic device capable of reducing the number of two-dimensional codes generated in encoding a large amount of tabular data into two-dimensional codes, and a method of displaying codes.

### SUMMARY OF THE INVENTION

To solve the above problems, there is provided an electronic device including: a display unit which displays a code generated based on tabular data; and a processor, wherein the processor performs: a compressing process of compressing numerical data having a plurality of digits and contained in the tabular data by reducing the number of digits of the numerical data; an encoding process of encoding the tabular data containing the numerical data compressed through the compressing process; and a code displaying process of displaying a code obtained by the encoding process on the display unit.

The present invention can encode a large amount of tabular data into a reduced number of two-dimensional codes.

### BRIEF DESCRIPTION OF THE SEVERAL VIEWS OF THE DRAWINGS

The above and further objects, features and advantages of the present invention will be made clearer by the following detailed description and the attached drawings, in which:

FIG. 1 is a schematic plan view of a scientific calculator to which an electronic device of the present invention is applied;

FIG. 2 is a block diagram of the internal configuration of the scientific calculator;

FIG. 3 is a flowchart describing computations for displaying tabular data on the scientific calculator;

FIG. 4A illustrates example tabular data appearing on the display in a statistical computation;

FIG. 4B illustrates example tabular data appearing on the display in a table computation using a spreadsheet;

FIG. 4C illustrates example tabular data appearing on the display in a computation in a mathematical table mode;

FIG. 5 is a flowchart describing procedures for encoding tabular data into a two-dimensional code and displaying the two-dimensional code on the scientific calculator;

FIG. 6 illustrates an example two-dimensional code appearing on the display;

FIG. 7A illustrates an example structure of numerical data;

FIG. 7B illustrates an example portion deleted from the numerical data;

FIG. 7C illustrates an example structure of compressed data; and

FIG. 8 is an example graph of the functional expression appearing on a smartphone screen in the computation in the mathematical table mode.

An electronic device in accordance with embodiments of the present invention will now be described with reference to the attached drawings. In the following description, the electronic device is applied to a scientific calculator. The present invention can also be applied to any electronic device capable of displaying any code such as a two-dimensional code on a display. The scope of the present invention should not be limited to the illustrated examples.

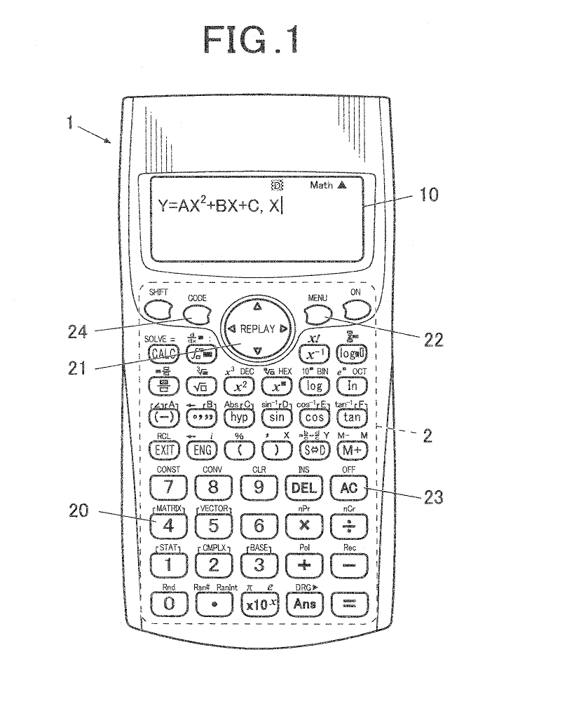

FIG. 1 is a plan view of a scientific calculator. The scientific calculator 1 includes an input key group 2 consisting of variable keys, and a display 10.

The input key group 2 receives user operations for inputting numerical values and elements in mathematical expressions, such as mathematical symbols, and operations for commanding various processes and includes multiple keys with specific functions. The input key group 2 includes numeric keys 20, a cursor key 21, a MENU key 22, an AC key 23, and a CODE key 24.

The numeric keys 20 receive operations for inputting numerical values. The cursor key 21 is pressed to move a cursor indicating a position to be edited or selected on the display 10 in a predetermined direction. In this embodiment, the cursor key 21 receives input in four, up, down, left, and right, directions.

The MENU key 22 is pressed by a user to set or select various functions. The AC key 23 is pressed to completely clear, for example, a computing operation having been done until that time. In this embodiment, pressing the AC key 23 with the display 10 displaying a two-dimensional code cancels the display of the two-dimensional code and returns the display 10 to an original state.

The CODE key 24 is pressed to encode the data appearing on the display 10 into a two-dimensional code and display the code.

The display 10 is composed of, for example, a reflective simple-matrix liquid crystal display and displays various data, such as characters, signs, symbols, expressions, and the computed results, and a two-dimensional code, such as a QR code, with multiple dots. The display 10 may be provided with a touch panel over the entire display screen.

The display of a two-dimensional code will be described below. The present invention can also be applied to the display of a one-dimensional code, such as a bar code.

### [Internal Configuration]

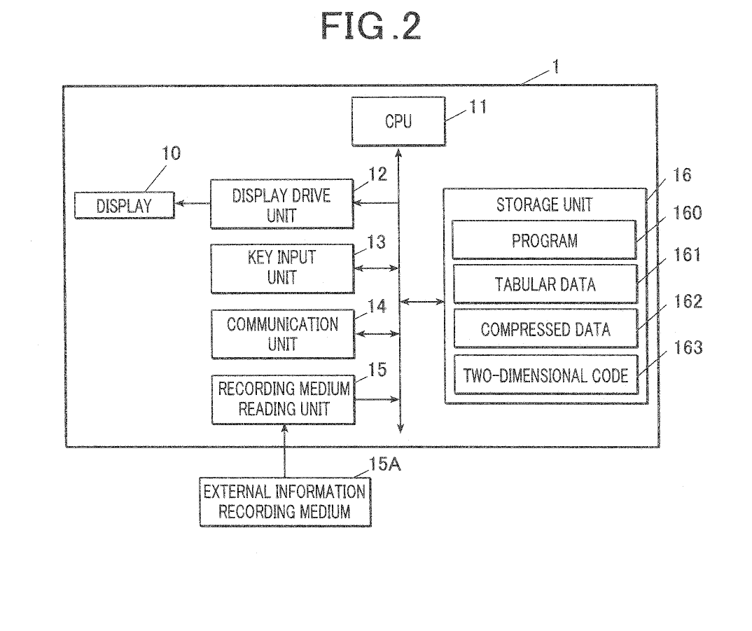

FIG. 2 is a block diagram of the internal configuration of the scientific calculator 1. The scientific calculator 1 includes a central processing unit (CPU) 11, a display drive unit 12, a key input unit 13, a communication unit 14, a recording medium reading unit 15, and a storage unit 16.

The display drive unit 12 controls the display of various pieces of information on the display 10 in accordance with control from the CPU 11. The display drive unit 12 adjusts the contrast ratio of the display on the display 10 through a key operation by the user.

In the case of a reflective simple-matrix liquid crystal display, a variation in applied voltage leads to variations in reflectance of a lighting (black) portion and a non-lighting (white) portion and thus a variation in the ratio of the reflectance of the white portion to the reflectance of the black portion, that is, a contrast ratio. The display drive unit 12 varies the value of a voltage applied to liquid crystals to vary the contrast ratio.

The key input unit 13 includes the input key group 2 and the optional touch panel and outputs a key input signal corresponding to a key operated by the user to the CPU 11. In response to the key input signal, the CPU 11 displays tabular data and/or a mathematical expression on the display 10, executes a computing operation, or performs various processes.

The scientific calculator 1 can be connected to, for example, a network (not shown), so that the communication unit 14 communicates, through the network, with an external device, such as a server and a computer, connected to the network.

The recording medium reading unit 15 reads information from an external information recording medium 15A mounted detachably, such as a USE memory. A program (described later) of the present invention may be read from the external information recording medium 15A through the recording medium reading unit 15. The program of the present invention may be read from the scientific calculator 1 to the external information recording medium 15A.

The storage unit 16 is memory that stores programs and data including tabular data and mathematical expressions and functions as the work area (described later) of the CPU 11.

In this embodiment, the storage unit 16 includes several storage areas including a storage area 160 storing a program for executing the functions of the scientific calculator 1, especially a program of the present invention for encoding tabular data into a two-dimensional code, a storage area 161 storing tabular data, a storage area 162 storing compressed data to be described later, and a storage area 163 storing a two-dimensional code generated and displayed on the display 10.

The CPU 11 comprehensively controls the individual units of the scientific calculator 1. In specific, the CPU 11 reads a program specified among system programs and various application programs stored in the respective areas of the storage unit 16, develops the program into the work area of the storage unit 16, and executes a process of interest in cooperation with the program developed in the storage unit 16. The CPU 11 controls the display drive unit 12 to execute necessary displays on the display 10.

### [Operation]

The operation of the scientific calculator 1 will now be described with reference to the flowcharts in the drawings.

### [Various Processes Using Tabular Data]

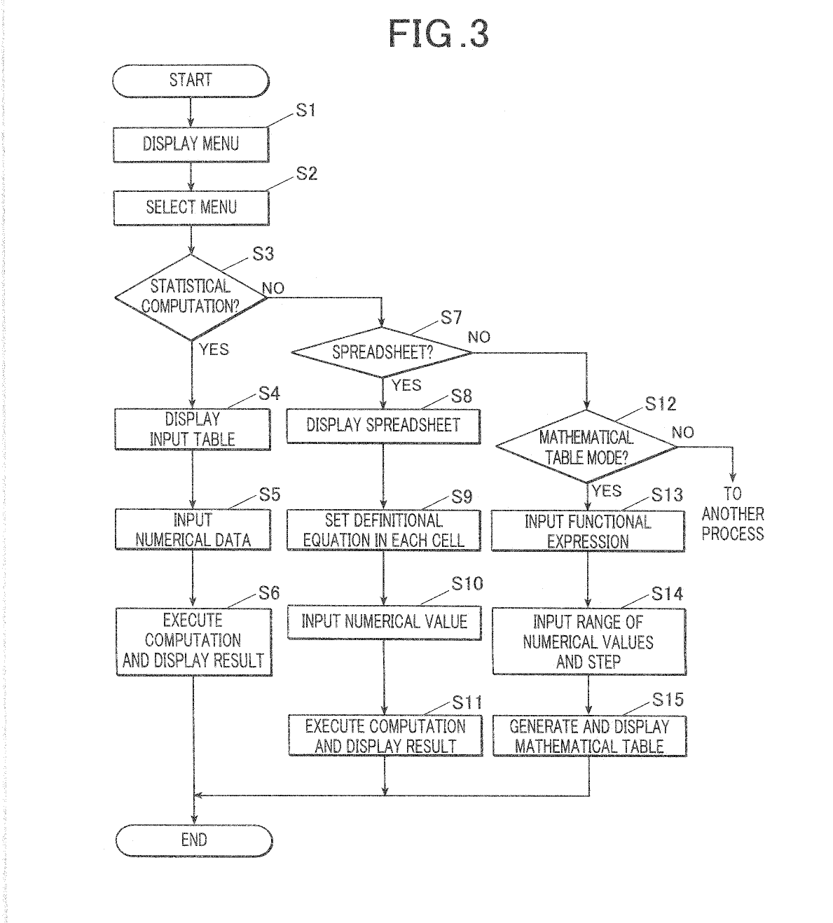

The procedure of computations using tabular data on the scientific calculator 1 will now be described with reference to the flowchart in FIG. 3. The computations using tabular data are exemplified by a statistical computation, a table computation using a spreadsheet, and a computation in a mathematical table mode. The present invention can also be applied to other computations using tabular data without any limitation.

Pressing the MENU key 22 of the scientific calculator 1 causes the CPU 11 to control the display drive unit 12 to display a menu screen showing the list of executable computations on the display 10 (Step S1), and then allows the user to select an item of a computation to be executed from the menu screen (Step S2).

### [Statistical Computation]

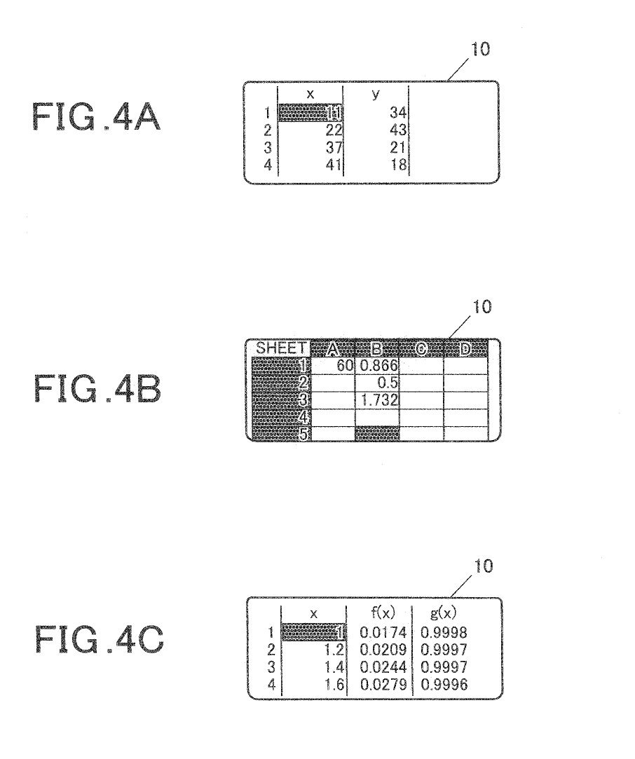

If the user selects the item “Statistical Computation” from the menu screen (Step S3: YES), the CPU 11 controls the display drive unit 12 to display an input table for inputting numerical data on the display 10 (Step S4), and then allows the user to input numerical data into each cell of the input table as shown in the FIG. 4A (Step S5). In this embodiment, the statistical computation is a two-variable statistical computation, numerical values are input into the x and y columns of the input table, and the input numerical data are stored in the storage area 161.

After the user completes the input of numerical data and commands the computation of a regression expression or average of x and y, the CPU 11 of the scientific calculator 1 executes the commanded computation and displays the result of the computation on the display 10 (Step S6).

### [Table Computation Using Spreadsheet]

If the user selects the item “Spreadsheet” from the menu screen (Step S7: YES), a spreadsheet appears on the display 10 (Step S8). After the user sets a definitional equation in each cell of the spreadsheet (Step S9) and inputs a numerical value in a predetermined cell (Step S10), the CPU 11 executes a computation by inserting the data into the definitional equation in each cell and then displays the result of the computation in each cell (Step S11).

For example, with reference to FIG. 4B, the user provides such definitions that the sine of a value input into a cell A1 is computed in a cell B1, the cosine in a cell B2, and the tangent in a cell B3. When the user inputs a numerical value “60” into the cell A1, the CPU 11 computes sin60°, cos60°, and tan60°, writes the results of the computations into the cells B1, B2, and B3 of the spreadsheet, and displays each value. The tabular data acquired by the computations is stored in the storage area 161.

### [Computation in Mathematical Table Mode]

If the user selects the item “Mathematical Table Mode” from the menu screen (Step S12: YES), the display 10 displays a screen for allowing the user to input a functional expression, the range of numerical values, and a step. After the user inputs a functional expression (Step S13) and then inputs the range of numerical values and a step (Step S14), the CPU 11 executes a computation by inserting each numerical value defined by the range of numerical values and the step into the input functional expression, generates a mathematical table containing each numerical value and the results of the computations, and displays the table on the display 10 (Step S15).

For example, with reference to FIG. 4C, the user inputs functional expressions, “f(x)=sin(x)” and “g(x)=cos(x)”, range x of numerical values, “1 to 5”, and step “0.2”, the CPU 11 computes sin1°, sin1.2°, sin1.4°, sin1.6°, . . . , and cos1°, cos1.2°, cos1.4°, cos1.6°, . . . , generates a mathematical table containing these numerical values and the results of the computations, and displays the table on the display 10. The tabular data is stored in the storage area 161.

If another process is selected in place of the item “Mathematical Table Mode” (Step S12: No), a normal computation of the scientific calculator, for example, is executed in accordance with the user operation.

### [Encoding Tabular Data Into Two-dimensional Code and Displaying the Two-dimensional Code]

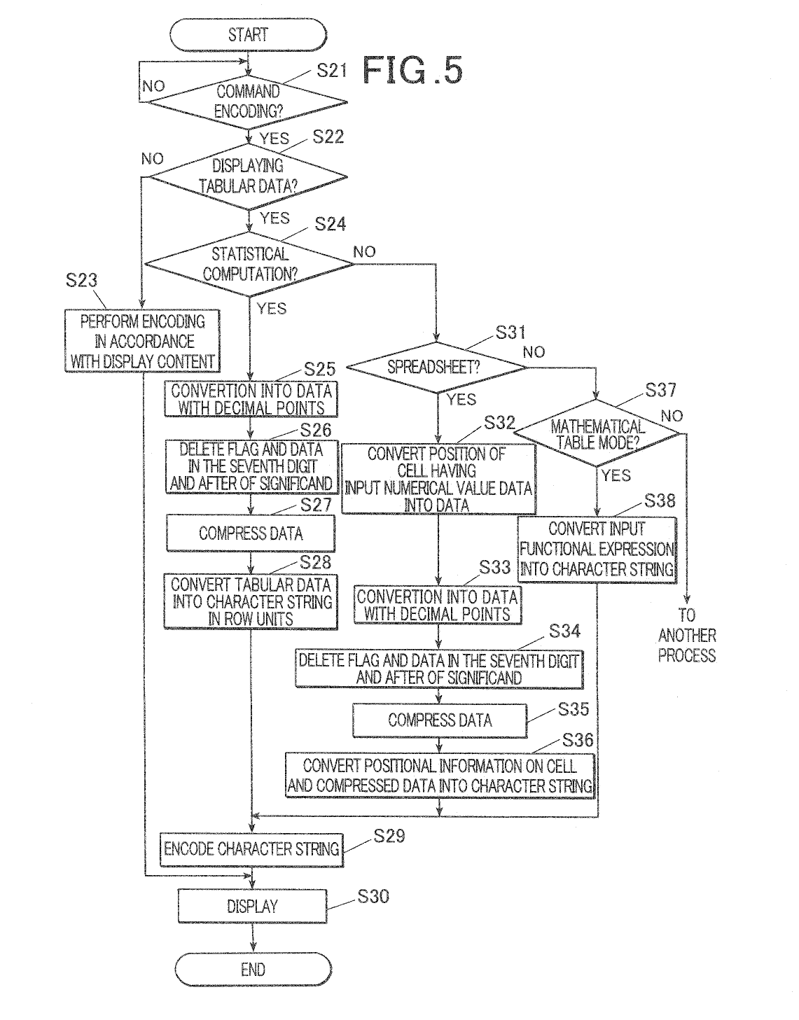

The procedures for encoding tabular data into a two-dimensional code and displaying the two-dimensional code on the scientific calculator 1 will now be described with reference to the flowchart in FIG. 5. The encoding for a statistical computation, a table computation using a spreadsheet, and a computation in a mathematical table mode as computations using tabular data will now be described. The present invention can also be applied to other computations using tabular data without any restriction.

When the user presses the CODE key 24 (See FIG. 1), the CPU 11 determines that a command to encode tabular data and/or a mathematical expression displayed on the display 10 is entered (Step S21: YES) and then determines whether such tabular data appears on the display 10. If such tabular data is not displayed (Step S22: NO), the CPU 11 performs normal encoding in accordance with the display content on the display 10 at that time (Step S23) and displays a two-dimensional code on the display 10 (Step S30).

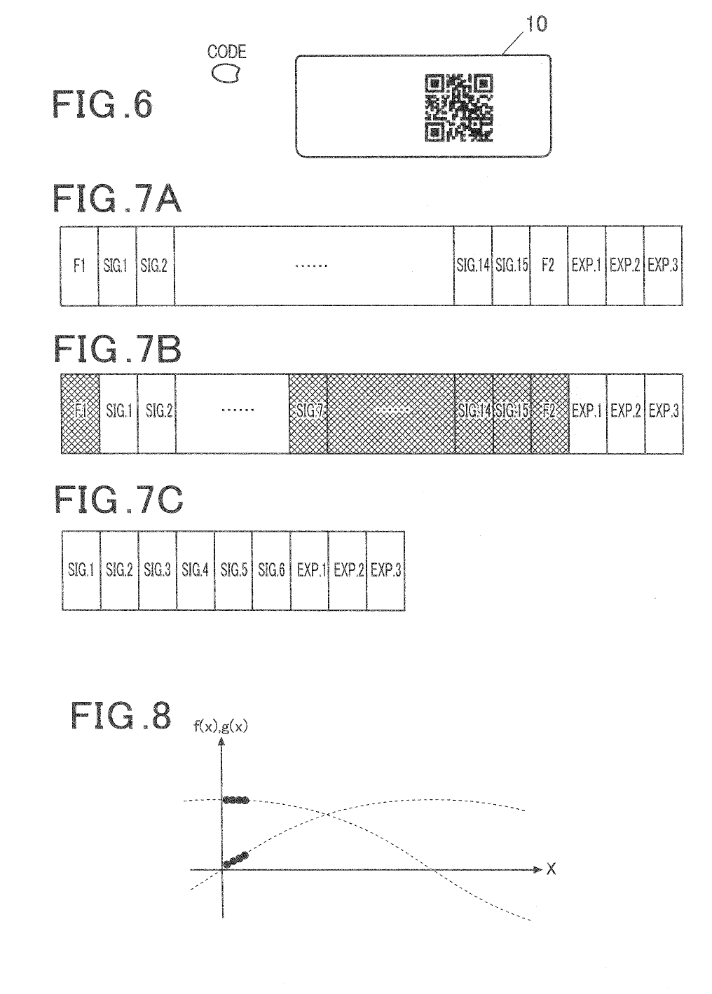

For example, if a mathematical expression or a character appears on the display 10 at that time, the CPU 11 encodes the mathematical expression or character and displays a two-dimensional code corresponding to the mathematical expression or character on the display 10 as shown in FIG. 6. Unlike the cases of tabular data to be described below, conversion of numerical data into a two-dimensional code does not involve the compression of the number of digits of the numerical data.

### [Encoding for Statistical Computation]

If the user commands encoding (Step S21: YES), if tabular data is displayed on the display 10 (Step S22: YES), and if the tabular data is acquired through [Statistical Computation] (Step S24: YES), the CPU 11 performs the following process.

If the numerical data input into each cell of the tabular data (See FIG. 4A) in the statistical computation includes data other than numbers with decimal points, for example, data expressed by a symbol, such as a radical sign (for example, √2), a fraction, or a mathematical expression, the CPU 11 converts such data into numerical data with decimal points so that all the numerical data become the numerical data with decimal points (Step S25).

Conversion of data without decimal points into numerical data with decimal points allows data expressed by a symbol, such as a radical sign, a fraction, or a mathematical expression and data expressed by decimal points to be equally handled and facilitates the following process at the CPU 11.

In this embodiment, in the conversion into numbers with decimal points, the CPU 11 expresses both numbers with decimal points converted from data without decimal points and originally input numerical data with decimal points, as the product of a significand having a predetermined number of digits by some power of 10.

In specific, with reference to FIG. 7A, the scientific calculator 1 divides numerical data to be computed into a fifteen-digit significand and a three-digit exponent and stores the numerical data in each digit in the binary-coded decimal (BCD) format. Namely, the numerical data is expressed by a flag F1 indicating a significand, significand data having a predetermined number of digits (fifteen digits in this case), a flag F2 indicating an exponent of some power of 10 to be multiplied by the significand, and exponent data having a predetermined number of digits (three digits in this case), in this order. For example, √2 is converted into a decimal as below:

√2=1.41421356237309 . . . ×10°

In this case, the CPU 11 expresses the decimal of √2 as below:

F1,1,4,1,4,2,1,3,5,6,2,3,7,3,0,9,F2,0,0,0 (1)

The CPU 11 then deletes the significand data in the seventh to fifteenth digits of the significand of the numerical data as shown with the shading in FIG. 7B to reduce the number of digits of the significand to six digits. The CPU 11 simultaneously deletes the flags F1 and F2 in the flag digits (Step S26).

The CPU 11 compresses the data remaining after the deletion of the flags and the significand data in the seventh digit and after of the significand by placing the data close together in order as shown in FIG. 7C (Step S27).

Hereinafter, the numerical data newly generated by the compression is referred to as compressed data to distinguish it from the original numerical data. In this example, the original twenty-digit numerical data (See FIG. 7A) is compressed into the nine-digit compressed data (See FIG. 7C). For example, √2 is compressed from the original numerical data shown in expression (1) into the following compressed data:

1,4,1,4,2,1,0,0,0 (2)

The CPU 11 then converts the tabular data composed of the compressed numerical data into a character string in row units (Step S28). In specific, in the case of the tabular data in the statistical computation in FIG. 4A, the CPU 11 disposes the compressed data of the data in the cell X1 (the compressed data of “11”) and then the compressed data of the data in the cell Y1 (the compressed data of “34”) in the first row, and then disposes the compressed data of the data in the cells X2 and Y2 (the compressed data of “22” and “43”) in the second row. In this way, the CPU 11 sequentially disposes the compressed data of the tabular data in row units.

The CPU 11 converts the sequentially-disposed compressed data into a character string in the American Standard Code for Information Interchange (ASCII) format. The character string converted in the ASCII format is encoded to generate a two-dimensional code (Step S29), and the generated two-dimensional code appears on the display 10 (Step S30).

In this embodiment, the CPU 11 stores the tabular data composed of the original numerical data, the compressed data, and the generated two-dimensional code in the storage areas 161, 162, and 163 (See FIG. 2) of the storage unit 16, respectively.

The user captures the two-dimensional code appearing on the display 10 with, for example, a smartphone with an imaging function. The data is transferred to a service center. The service center calculates information for displaying, for example, the graph of a regression expression from the data and transfers the information to the smartphone. The smartphone displays the graph of the regression expression on the screen on the basis of the information.

In this example, the compression deletes the significand data in the seventh digit and after of the significand to reduce the number of digits of the significand to six digits. However, the present invention should not be limited thereto. The extent to which the significand is reduced in the number of digits (compressed) may be determined by, for example, the acceptable range of deviation of the graph of the regression expression based on the compressed data from the graph of the regression expression calculated on the basis of the original numerical data before the compression, appearing on the smartphone screen.

A reduction in the amount of tabular data to be encoded reduces the number of generated two-dimensional codes and a burden on the user capturing the codes with the smartphone.

### [Encoding for Table Computation Using Spreadsheet]

If the user commands encoding while the tabular data acquired through [Table Computation Using Spreadsheet] is displayed (Step S31: YES), the following process is performed.

A spreadsheet often contains blank cells having no input numerical data as shown in FIG. 4B,

The CPU 11 firstly converts positional information on cells having input numerical data into data (Step S32).

Namely, if numerical data is input as shown in FIG. 4B, the CPU 11 checks for the column A vertically in the order of A1, A2, . . . and assigns 1 to the cell having input numerical data and 0 to the cells having no input numerical data. The CPU 11 converts positional information on the cell having input numerical data into data in eight-bit units as 1,0,0,0,0, . . . for the column A. Subsequently, the CPU 11 checks for the column B vertically in the order of B1, B2, . . . and converts positional information on the cells having input numerical data into data as 1,1,1,0,0, . . . for the column B.

As in [Encoding for Statistical Computation], the CPU 11 converts each numerical data into numerical data with decimal points (Step S33), deletes the flags and the significand data in the seventh digit and after of the significand (Step S34), and compresses the numerical data (Step S35).

The CPU 11 disposes the positional information on the cells having input numerical data before the compressed data of the numerical values in the cells at the positions indicated by the information, and converts the data into a character string in the ASCII format, thereby converting the positional information on the cells and the compressed data into a character string (Step S36).

The character string converted in the ASCII format is encoded to generate a two-dimensional code (Step S29), and the code appears on the display 10 (Step S30). The CPU 11 stores the spreadsheet (tabular data) composed of the original numerical data, the compressed data, and the generated two-dimensional code into the storage areas 161, 162, and 163 of the storage unit 16, respectively.

In this embodiment, the number of generated two-dimensional codes can be reduced in [Encoding for Table Computation Using Spreadsheet] as in [Encoding for Statistical Computation].

### [Encoding for Computation in Mathematical Table Mode]

In [Computation in Mathematical Table Mode], the input of functional expressions, such as f(x) and g(x), the range of numerical values, and a step by the user executes computations, generates a mathematical table, and displays the table on the display 10. (See FIG. 4C.)

In the mathematical table mode, a possible usage is that the user captures a two-dimensional code with a smartphone with an imaging function and transfers the code to a service center, the service center transfers information for displaying the graph of a functional expression, such as f(x), to the smartphone, and the graph of the functional expression, such as f(x), appears on the smartphone screen on the basis of the information.

In the case of the computations in the mathematical table mode in FIG. 4C, a possible usage is that the user inputs functional expressions, “f(x)=sin(x)” and “g(x)=cos(x)”, and the graphs of sin(x) and cos(x) appear on the smartphone screen as shown in FIG. 8.

To display the graph of the functional expressions on the smartphone screen, the input data of the functional expressions, the range of numerical values, and the step may be sent to the service center instead of sending the numerical data of the tabular data acquired through the computations to the service center.

The service center may generate information necessary for displaying the graphs in FIG. 8 only with information on the functional expressions and multiple values to be inserted in the functional expressions.

In this embodiment, with reference to the flowchart in FIG. 5, if the user commands encoding (Step S21: YES) while tabular data is displayed through [Computation in Mathematical Table Mode] (Step S37: YES), the functional expressions input by the user are converted into a character string in the ASCII format without the compression of the numerical data of the tabular data (Step S38).

The CPU 11 may also convert the information on the range of numerical values and step input by the user into a character string in the conversion of the functional expressions into a character string, depending on the type of graph to be displayed on the smartphone screen. The CPU 11 encodes the generated character string to generate a two-dimensional code (Step 529) and displays the code on the display 10 (Step S30).

Since data to be encoded with tabular data displayed in the mathematical table mode is a functional expression that is the source of the table, the number of generated two-dimensional codes is reduced.

What is claimed is:

1. An electronic device comprising:
a display unit which displays a code generated based on tabular data; and
a processor, wherein
the processor performs:
a compressing process of compressing numerical data having a plurality of digits and contained in the tabular data by reducing the number of digits of the numerical data;
an encoding process of encoding the tabular data containing the numerical data compressed through the compressing process; and
a code displaying process of displaying a code obtained by the encoding process on the display unit.

2. The electronic device according to claim 1, further comprising:
a storage unit storing the tabular data; wherein
the processor further performs:
a decimal converting process of converting data other than a decimal contained in the tabular data stored in the storage unit into numerical data with a decimal point, and wherein
the compressing process compresses the numerical data with the decimal point.

3. The electronic device according to claim 1, wherein if the tabular data contains a cell having the numerical data and a cell having no numerical data, the encoding process encodes positional information on the cell having the numerical data and the numerical data in the cell.

4. The electronic device according to claim 1, wherein the processor further performs:
a receiving process of receiving an encoding command from a user;
a determining process of determining whether the tabular data is displayed when the encoding command is received;
a normal encoding process of encoding data being displayed without compressing the numerical data, if the determining process determines that the tabular data is not displayed;
a discriminating process of discriminating a type of a computation having generated the tabular data, if the determining process determines that the tabular data is displayed; and
a mathematical-expression encoding process of encoding at least a mathematical expression that is a source of a predetermined computation having generated the tabular data, instead of the tabular data, if the discriminating process discriminates the predetermined computation.

5. The electronic device according to claim 1, wherein the code displaying process displays a two-dimensional code.

6. The electronic device according to claim 1, wherein the numerical data contains significand data and exponent data each having a fixed number of digits, and the compressing process reduces the number of digits of the significand data.

7. A method of displaying a code on an electronic device which includes a display unit which displays a code generated based on tabular data, the method comprising the steps of:
(a) compressing numerical data having a plurality of digits and contained in the tabular data by reducing the number of digits of the numerical data;
(b) encoding the tabular data containing the numerical data compressed in step (a); and
(c) displaying the code obtained in step (b) on the display unit.

8. The method of displaying the code according to claim 7, further comprising the steps of:
(d) storing the tabular data in a memory; and
(e) converting data other than a decimal contained in the tabular data stored in the memory into numerical data with a decimal point; and wherein
step (a) compresses the numerical data with the decimal point.

9. The method of displaying the code according to claim 7, wherein if the tabular data contains a cell having the numerical data and a cell having no numerical data, step (b) encodes positional information on the cell having the numerical data and the numerical data in the cell.

10. The method of displaying the code according to claim 7, further comprising the steps of:
(f) receiving an encoding command from a user;
(g) determining whether the tabular data is displayed when the encoding command is received;
(h) encoding data being displayed without compressing the numerical data if step (g) determines that the tabular data is not displayed;
(i) discriminating a type of a computation having generated the tabular data if step (g) determines that the tabular data is displayed; and
(j) encoding at least a mathematical expression that is a source of a predetermined computation having generated the tabular data, instead of the tabular data, if step (i) discriminates the predetermined computation.

11. The method of displaying the code according to claim 7, wherein step (c) displays a two-dimensional code.

12. The method of displaying the code according to claim 7, wherein the numerical data contains significand data and exponent data each having a fixed number of digits, and step (a) reduces the number of digits of the significand data.

13. A non-transitory recording medium recording a program which causes a computer equipped with a display unit which displays a code generated based on tabular data to perform:
a compressing process of compressing numerical data having a plurality of digits and contained in the tabular data by reducing the number of digits of the numerical data;
an encoding process of encoding the tabular data containing the numerical data compressed through the compressing process; and
code displaying process of displaying the code obtained by the encoding process on the display unit.

14. The recording medium according to claim 13, wherein
the program further causes the computer to perform:
a storing process of storing the tabular data in a memory; and
a decimal converting process of converting data other than a decimal contained in the tabular data stored in the memory into numerical data with a decimal point, and wherein
the compressing process compresses the numerical data with the decimal point.

15. The recording medium according to claim 13, wherein if the tabular data contains a cell having the numerical data and a cell having no numerical data, the encoding process encodes positional information on the cell having the numerical data and the numerical data in the cell.

16. The recording medium according to claim 13, wherein the program further causes the computer to perform:
a receiving process of receiving an encoding command from a user;
a determining process of determining whether the tabular data is displayed when the encoding command is received;
a normal encoding process of encoding data being displayed without compressing the numerical data, if the determining process determines that the tabular data is not displayed;
a discriminating process of discriminating a type of a computation having generated the tabular data, if the determining process determines that the tabular data is displayed; and
a mathematical-expression encoding process of encoding at least a mathematical expression that is a source of a predetermined computation having generated the tabular data, instead of the tabular data, if the discriminating process discriminates the predetermined computation.

17. The recording medium according to claim 13, wherein the code displaying process displays a two-dimensional code.

18. The recording medium according to claim 13, wherein the numerical data contains significand data and exponent data each having a fixed number of digits, and the compressing process reduces the number of digits of the significand data.
